(19) United States
(12) Patent Application Publication
(10) Pub. No.: US 2026/0087011 A1
(43) Pub. Date: Mar. 26, 2026

(54) ELECTRONIC APPARATUS, METHOD, AND COMPUTER-READABLE RECORDING MEDIUM FOR DISPLAYING SEARCH PATH

(71) Applicant: Ascent Korea Co., Ltd., Seoul (KR)

(72) Inventor: Hong Kim, Seongnam-si (KR)

(73) Assignee: Ascent Korea Co., Ltd., Seoul (KR)

(21) Appl. No.: 19/311,272

(22) Filed: Aug. 27, 2025

(30) Foreign Application Priority Data
Sep. 24, 2024 (KR) 10-2024-0128599

(51) Int. Cl. G06F 16/2453; G06F 16/248

(52) U.S. Cl. CPC G06F 16/24542; G06F 16/248

(57) ABSTRACT

A method for displaying a search path according to an embodiment disclosed herein includes displaying an object for receiving a user input for at least one of a search keyword, a location of the search keyword within a base search path, or an alignment criterion of the base search path, displaying a first search path including at least one of a first keyword located before the search keyword or a second keyword located after the search keyword based on the location of the search keyword, in response to receiving a user input for at least one of the search keyword, the location of the search keyword, or the alignment criterion, and displaying, based on a user input for keyword clustering, at least one of a result of clustering the first keyword or a result of clustering the second keyword in the first search path.

### CROSS REFERENCE TO RELATED APPLICATION

This application claims priority to and the benefit of Korean Patent Application No. 10-2024-0128599 filed in the Korean Intellectual Property Office on September 24, 2024, the entire contents of which are incorporated herein by reference.

### TECHNICAL FIELD

The technical idea of the present disclosure relates to an electronic apparatus and a method for displaying a search path.

### BACKGROUND OF THE INVENTION

Search engine optimization (SEO) is a process of achieving a high ranking in a search engine result page (SERP) to increase the visibility of a website. One of the important components of the search engine optimization is keyword extraction. The keyword extraction aims to improve visibility in a search engine by identifying words or phrases that a user is highly likely to enter in the search engine and reflecting the identified words and phrases into a content of the website.

Optimum keywords may be extracted by means of a variety of methods, and a plurality of extracted keywords may be provided to the user through a variety of visualization tools. However, it may be difficult to determine which keywords lead the user to a target keyword, based only on listing the plurality of extracted keywords. It may also be difficult to search for a competitor searched by a potential customer or a need of the potential customer . Therefore, there is a growing interest in a technology that visualizes a plurality of extracted keywords to provide information desired by the user.

### SUMMARY OF THE INVENTION

A technical object to be achieved by the present disclosure is to visualize a search path by connecting a previous keyword and/or a subsequent keyword of a search keyword (or a target keyword) on the search path.

A technical object to be achieved by the present disclosure is to provide a visualization tool that may search for a brand and/or a keyword that is/are connected to the search keyword.

A technical object to be achieved by the present disclosure is to generate a keyword cluster that is clustered based on a search intention of a user in a search path composed mainly of the search keyword.

A technical object to be achieved by the present disclosure is to simultaneously display the search path, which is composed mainly of the search keyword, and the keyword cluster, which is generated based on the search path, on one screen.

A technical object to be achieved by the present disclosure is to provide a visualization tool that provides the search path and the keyword cluster, making it possible to determine the search intention of the user.

An exemplary embodiment of the present disclosure provides a method for displaying a search path, including: displaying an object for receiving a user input for at least one of a search keyword, a location of the search keyword within a base search path, or an alignment criterion of the base search path; displaying a first search path including at least one of a first keyword located before the search keyword or a second keyword located after the search keyword based on the location of the search keyword, in response to receiving a user input for at least one of the search keyword, the location of the search keyword, or the alignment criterion; and displaying, based on a user input for keyword clustering, at least one of a result of clustering the first keyword or a result of clustering the second keyword in the first search path.

In an exemplary embodiment, the method may further include: displaying, according to a determination that the location of the search keyword is a first location indicating an entirety of the base search path, the first keyword on a previous path of the search keyword on the first search path, and displaying the second keyword on a subsequent path thereof; displaying, according to a determination that the location of the search keyword is a second location indicating a start of the base search path, the second keyword on the subsequent path of the search keyword on the first search path; and displaying, according to a determination that the location of the search keyword is a third location indicating an end of the base search path, the first keyword on the previous path of the search keyword on the first search path.

In an exemplary embodiment, the method may further include displaying, on a left side of a screen, a filter object for selecting and displaying a keyword determined based on a filter in the first search path.

In an exemplary embodiment, the method may further include: displaying, according to a determination that the filter input through the filter object is a first filter that allows the search intention to be displayed in the keyword, an identifier in the keyword, the identifier corresponding to the search intention in the first search path; displaying, according to a determination that the filter input through the filter object is a second filter that allows a search exposure type, in which the keyword is exposed, to be displayed in a search result page, an identifier in the keyword, the identifier corresponding to the search exposure type in the first search path; displaying, according to a determination that the filter input through the filter object is a third filter that allows search volume variation information to be displayed in the keyword, an identifier in the keyword, the identifier corresponding to the search volume variation information in the first search path; and displaying, according to a determination that the filter input through the filter object is a fourth filter that allows a demographic characteristic to be displayed in the keyword, an identifier in the keyword, the identifier corresponding to the demographic characteristic in the first search path.

In an exemplary embodiment, the method may further include displaying the second search path generated based on a keyword cluster, which is generated according to a result of clustering a plurality of users, and the first search path, and the keyword cluster may be generated based on search data of the plurality of users.

In an exemplary embodiment, the method may further include displaying a name of the keyword cluster generated based on a keyword included in the keyword cluster.

In an exemplary embodiment, the method may further include receiving, in the first search path, user inputs for a keyword of a first point and a keyword of a second point, the keywords respectively indicating a start and an end of a third search path for the user to desire to analyze, and displaying an identifier for the third search path overlaid on the first search path.

In an exemplary embodiment, the method may further include switching the object to and displaying a page displaying a fourth search path included in the third search path, according to a user input for the third search path.

In an exemplary embodiment, the method may further include displaying a list of a fifth search path of keywords that are the same as the keyword of the first point and are different from the keyword of the second point in the corresponding page.

In an exemplary embodiment, the method may further include: displaying the first search path in a first area of a screen, and displaying a second search path in a second area of the screen; and displaying an identifier of a keyword, which is included in a keyword cluster selected in the second search path, in the first search path of the first area.

In an exemplary embodiment, the method may further include displaying a first search path of a first time point in a first area of a screen, and displaying a first search path of a second time point, which is a time point earlier than the first time point, in a second area of the screen.

In an exemplary embodiment, the method may further include: displaying a first object for receiving a first search keyword in a first area of a screen and a second object for receiving a second search keyword in a second area of the screen; displaying the search path of the first search keyword, input through the first object, in the first area; and displaying the search path of the second search keyword, input through the second object, in the second area.

Another exemplary embodiment of the present disclosure provides a computer-readable recording medium having a program for displaying a search path recorded therein, in which the program is configured to display an object for receiving a user input for at least one of a search keyword, a location of the search keyword within a base search path, or an alignment criterion of the base search path, to display a first search path including at least one of a first keyword located before the search keyword or a second keyword located after the search keyword based on the location of the search keyword, in response to receiving a user input for at least one of the search keyword, the location of the search keyword, or the alignment criterion, and to display, based on a user input for keyword clustering, at least one of a result of clustering the first keyword or a result of clustering the second keyword in the first search path.

Still another exemplary embodiment of the present disclosure provides an electronic apparatus including: a memory; and one or more processors, in which the one or more processors is configured to display an object for receiving a user input for at least one of a search keyword, a location of the search keyword within a base search path, or an alignment criterion of the base search path, to display a first search path including at least one of a first keyword located before the search keyword or a second keyword located after the search keyword based on the location of the search keyword, in response to receiving a user input for at least one of the search keyword, the location of the search keyword, or the alignment criterion, and to display, based on a user input for keyword clustering, at least one of a result of clustering the first keyword or a result of clustering the second keyword in the first search path.

According to an exemplary embodiment of the present disclosure, it is possible to visualize a search path by connecting a previous keyword and/or a subsequent keyword of a search keyword (or a target keyword) on the search path.

According to an exemplary embodiment of the present disclosure, it is possible to provide a visualization tool that may search for a brand and/or a keyword that are/is connected to the search keyword.

According to an exemplary embodiment of the present disclosure, it is possible to generate a keyword cluster that is clustered based on a search intention of a user in a search path composed mainly of the search keyword.

According to an exemplary embodiment of the present disclosure, it is possible to simultaneously display the search path, which is composed mainly of the search keyword, and the keyword cluster, which is generated based on the search path, on one screen.

According to an exemplary embodiment of the present disclosure, it is possible to provide a visualization tool that provides the search path and the keyword cluster, thereby making it possible to determine the search intention of the user.

### BRIEF DESCRIPTION OF THE DRAWINGS

FIG. 1 is a diagram illustrating a system for displaying a search path according to an exemplary embodiment of the present disclosure.

FIG. 2 is a diagram illustrating a screen for displaying a search path according to an exemplary embodiment of the present disclosure.

FIG. 3 is a diagram illustrating a first keyword and a second keyword according to an exemplary embodiment of the present disclosure.

FIGS. 4A to 4D are diagrams illustrating filters according to various exemplary embodiments of the present disclosure.

FIG. 5 is a diagram illustrating a keyword cluster according to an exemplary embodiment of the present disclosure.

FIG. 6 is a diagram illustrating a third search path according to an exemplary embodiment of the present disclosure.

FIG. 7 is a diagram illustrating a fourth search path according to an exemplary embodiment of the present disclosure.

FIG. 8 is a diagram illustrating a screen for displaying a first search path and a second search path according to an exemplary embodiment of the present disclosure.

FIG. 9 is a diagram illustrating a screen for displaying a first search path at a first time point and a first search path at a second time point according to an exemplary embodiment of the present disclosure.

FIG. 10 is a diagram illustrating a screen for displaying a search path of a first search keyword and a search path of a second search keyword according to an exemplary embodiment of the present disclosure.

FIG. 11 is a flowchart illustrating a method for displaying a search path according to an exemplary embodiment of the present disclosure.

FIG. 12 is a diagram illustrating an electronic apparatus according to various exemplary embodiments of the present disclosure.

### DETAILED DESCRIPTION OF THE INVENTION

Hereinafter, preferred exemplary embodiments of the present disclosure will be described in detail with reference to the accompanying drawings. It should be noted that the same components in the drawings are denoted by the same reference numerals and symbols as possible even if they are indicated on different drawings. Hereinbelow, in describing the present disclosure, detailed description of associated known function or constitutions will be omitted if it is determined that they unnecessarily make the gist of the present disclosure unclear.

Further, when any part “includes” or “comprises” any component, unless explicitly described to the contrary, the word “include” or “comprise” and variations such as “includes”, “comprises”, “including” or “comprising” will be understood to imply the inclusion of stated components but not the exclusion of any other components.

It is also to be understood that the terms used herein is for the purpose of describing embodiments only and is not intended to limit the present disclosure. In this specification, singular forms include even plural forms unless the context clearly indicates otherwise. In this specification, the terms “include,” “comprise,” “provided with,” “have,” and the like do not exclude the presence or addition of one or more other components other than the mentioned components.

In this specification, the terms “or”, “at least one”, and the like may represent one of the listed words together, or may represent a combination of two or more thereof. For example, “A or B”, “and “at least one of A and B” may include A or B, or may include both A and B.

In this specification, in a description according to “for example” or the like, presented information such as a recited characteristic, variable, or value may not exactly match, and various exemplary embodiments of the present disclosure should not be limited to effects such as variations including tolerances, measurement errors, limitations of measurement accuracy, and other factors that are commonly known.

Terms including as first, second, and the like may be used for describing various components, but the components should not be limited by the terms. In addition, the terms should not be construed to limit an order of each component, but may be used for the purpose of distinguishing one component from another component. For example, a “first component” may be referred to as a “second component”, and similarly, the “second component” may also be referred to as the “first component”.

Respective blocks of processing flowcharts and accompanied by this specification and combinations of the flowcharts may be performed by computer program instructions. Since the computer program instructions may be mounted on a universal computer, a special computer or a processor of other programmable data processing equipment, the instructions performed by the computer or a processor of other programmable data processing equipment generate a means of performing functions described in the flowchart block(s).

The computer program instructions may also be stored in a computer usable or computer readable memory which may direct a computer or other programmable data processing equipment in order to implement a function in a specific scheme, and the instructions stored in the computer usable or computer readable memory can also produce manufacturing items including an instruction means performing a function described in the flowchart block(s).

Since the computer program instructions can also be mounted on the computer or other programmable data processing equipment, instructions, which perform the computer or other programmable data processing equipment by generating a processor executed by the computer as a series of operational steps are performed on the computer or other programmable data processing equipment, can provide steps for executing the functions described in the flowchart block(s).

Further, each block may represent a part of a module, a segment, or a code that includes one or more executable instructions for executing a specified logical function(s). In addition, in several alternative execution examples, functions mentioned in blocks may also occur out of order. For example, two successive illustrated blocks may be performed substantially concurrently or the blocks may sometimes be performed in reverse order according to the corresponding function.

The “electronic apparatus” or “terminal” mentioned in this specification may be implemented as a computer or a hand-held terminal capable of connecting to a server or another terminal through a network. Here, examples of the computer includes a notebook having a Web browser, a desktop, a laptop, and the like, and the portable terminal is a wireless communication device with portability and mobility, and examples thereof may include communication-based terminals such as International Mobile Telecommunication (IMT), Code Division Multiple Access (CDMA), W-Code Division Multiple Access (W-CDMA), Long Term Evolution (LTE), and the like, and all kinds of handheld-based wireless communication devices such as a smartphone, a tablet PC, and the like. In addition, examples of the “electronic apparatus” or “terminal” mentioned in this specification may also include a processor, a memory for storing and executing program data, a permanent storage such as a disk drive, a communication port for communicating with an external apparatus, and a user interface device such as a touch panel, a key, a button, and the like.

In the present disclosure, methods implemented as software modules or algorithms may be stored on a computer-readable recording medium as computer-readable codes or program instructions executable on the processor. Here, examples of computer-readable recording media may include magnetic storage media (e.g., read-only memory (ROM), random-access memory (RAM), floppy disks, hard disks, etc.) and optical reading media (e.g., CD-ROM, Digital Versatile Disc (DVD)). The computer-readable recording media may be distributed and executed on network-connected computer systems.

An artificial intelligence model (or model) may be implemented as a neural network (or artificial neural network), and may operate based on a statistical learning algorithm that mimics a biological nerve in machine learning and cognitive science. The neural network may refer to an overall model in which artificial neurons (nodes) forming a network by combining synapses have a problem-solving ability by changing coupling strength of synapses through learning. The neural network may be composed of a plurality of neural network layers, and illustratively, the neural network may include an input layer, a hidden layer, and an output layer. Each of the plurality of neural network layers may include at least one node and at least one weight, and may perform a neural network operation through an operation between an operation result of a previous layer and the weight. The at least one weight of the plurality of the neural network layers may be optimized according to a learning result of the artificial intelligence model. For example, the at least one weight may be updated so that a loss value or a cost value obtained from the artificial intelligence model during a learning process is reduced or minimized. The neural network may infer a result to be predicted from any input.

A learning method of the artificial intelligence model may be classified into supervised learning in which input data and output data are provided as training data according to a learning method, and a correct answer (output data) corresponding to a problem (input data) is determined, unsupervised learning in that only input data is provided without output data, and a correct answers (output data) are not determined, and reinforcement learning in which a reward is given every time an action is taken in a current state, and learning is performed in a direction of maximizing the reward. Alternatively, the learning method may be classified according to an architecture that is a structure of the learning model.

In the exemplary embodiments of the present disclosure, the artificial intelligence model may use at least one of various artificial intelligence structures and algorithms, such as a Convolution Neural Network (CNN) such as GoogleNet, AlexNet, VGG Network, etc., a Region with Convolution Neural network (R-CNN), a Region Proposal Network (RPN), a Recurrent Neural Network (RNN), a Stacking-based deep Neural Network (S-DNN), State-Space Dynamic Neural Network (S-SDNN), a Deconvolution Network, a Deep Belief Network (DBN), a Restricted Boltzman Machine (RBM), a Fully Convolutional Network, a Long Short-Term Memory (LSTM) Network, a Classification Network, a Generative Modeling, an eXplainable AI, a Continual AI, a Representation Learning, an AI for Material Design, BERT, SP-BERT, MRC/QA, Text Analysis, Dialog System, GPT-3, GPT-4 for natural language processing, Visual Analytics, Visual Understanding, Video Synthesis for vision processing, Anomaly Detection, Prediction, Time-Series Forecasting, Optimization, Recommendation, Data Creation for ResNet data intelligence, and the like, and the above-described embodiments are merely examples of the artificial intelligence structure and algorithm used according to the exemplary embodiments of the present disclosure, and are not intended to limit the artificial intelligence structure or algorithm used according to the exemplary embodiments of the present disclosure.

In the present disclosure, a language model is a part of natural language processing (NLP) technology, and relates to a system that learns a structure and pattern of a specific language to understand and generate text data. The present disclosure relates to a language model that analyzes a relationship between words, sentences, and paragraphs based on large-scale text data, and predicts linguistic meaning or generates new text based on the relationship. The language model is used to analyze given text data, understand grammar, meaning, and contextual information included therein, and derive accurate results from various natural language processing tasks.

The language model processes text data based on statistical techniques and machine learning algorithms. For large-scale language models, millions to billions of parameters are used to learn patterns in language, which gives them the ability to understand and infer context. For example, given the input “The cat is on the” in a given sentence, a language model can predict words such as “mat” based on this. This allows the language model to go beyond simply calculating word frequencies, and to derive natural and meaningful results through contextual understanding.

The language model according to the present disclosure is mainly implemented by utilizing a machine learning algorithm, in particular, a deep neural network. The neural network effectively analyzes text data through a multilayer structure, and gradually learns a pattern and a structure of text in each layer, thereby enabling more precise language processing. The language model is based on a transformer architecture, and greatly improves language understanding and generation ability by improving parallel processing ability and optimizing learning on large-scale data.

The language model is a core technology of natural language processing, and plays an important role in understanding and generating text data, thereby improving user experience in various applications and effectively processing complexity of human language.

Unless otherwise defined, all terms used in the present specification may be used as the meaning which may be commonly understood by the person with ordinary skill in the art, to which the present disclosure pertains. Further, terms defined in commonly used dictionaries should not be interpreted in an idealized or excessive sense unless expressly and specifically defined.

Hereinafter, various exemplary embodiments of the present disclosure will be described with reference to the accompanying drawings.

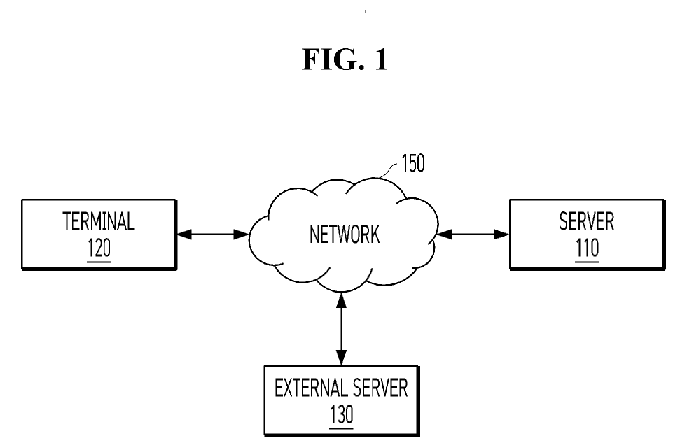

FIG. 1 is a diagram illustrating a system for displaying a search path according to an exemplary embodiment of the present disclosure.

In an exemplary embodiment, a server 110 may be an apparatus that provides a service for displaying a search path. The server 110 may be an apparatus that provides keywords required for marketing to users. The server 110 may provide a recommendation keyword that helps optimize a search engine based on keywords input by the user through a terminal 120. The server 110 may generate a search path based on the keyword based on the keyword input by the user and search data of another user. The search data may be a record of a search action which the user performs through the search engine. The server 110, based on the search data, may identify a pattern in which the user continuously searches for a specific topic (or keyword).

The search path may represent a series of search actions which the user performs through the search engine. The search path may be generated based on a record obtained by continuously searching for a specific topic by the user.

In an exemplary embodiment, an external server 130 may be the search engine. The search engine is a software system that finds information related to a query (e.g., a keyword) input by the user on a web. As one function of the search engine, the search engine may search a database in which various search words (or keywords) are stored to start with the keyword input by the user or obtain an associated keyword including the keyword. Through the search path, the user may obtain an analysis result of which keyword a potential customer is finding before searching for a specific brand, where another brand is being compared with the specific brand, or what is motivated to purchase when selecting a product.

The server 110, the terminal 120, and the external server 130 may communicate with each other through a network 150. The network 150 refers to a connection structure in which information may be exchanged between respective nodes such as devices, terminals, and servers, and examples of the network 150 include a 3rd Generation Partnership Project (3GPP) network, a Long Term Evolution (LTE) network, a 5G network, a World Interoperability for Microwave Access (WIMAX) network, Internet, a Local Area Network (LAN), Wireless Local Area Network (LAN), a Wide Area Network (WAN), a Personal Area Network (PAN), a Wi-Fi network, a Bluetooth network, a satellite broadcasting network, an analog broadcasting network, a Digital Multimedia Broadcasting (DMB) network, etc., but is not limited thereto.

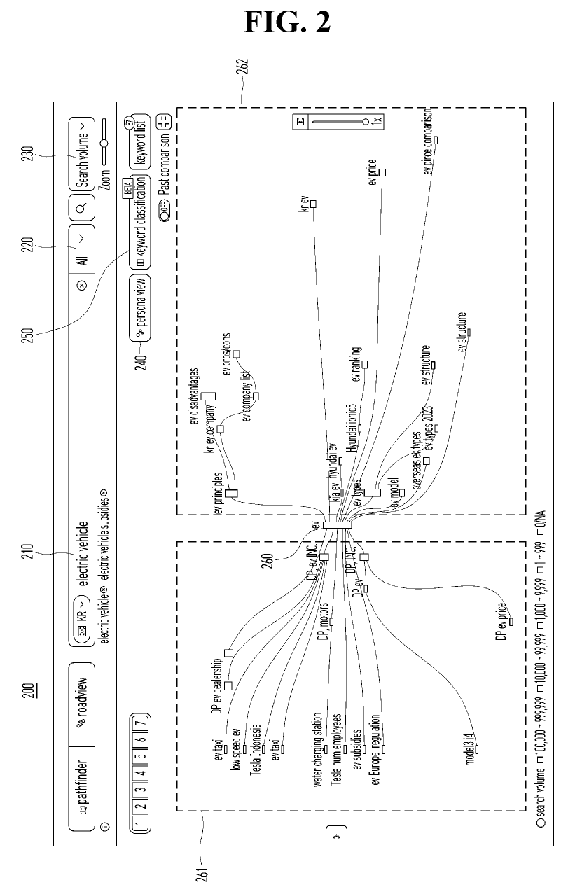

FIG. 2 is a diagram illustrating a screen for displaying a search path according to an exemplary embodiment of the present disclosure.

If only recommendation keywords are just listed, it may be difficult for the user to determine through which keywords the potential customer reaches a targeted target keyword. Further, it may be difficult for the user to search for a competitor searched by the potential customer or a need desired by the potential customer. However, by providing the search path to the user by the terminal 120, the user may provide a visualization tool that allows the user to easily determine how the potential customer reaches the targeted target keyword, and further, the user may determine the competitor searched by the potential consumer or the need desired by the potential consumer. The present disclosure provides the visualization tool that enables the user to derive a desired analysis result through the search path.

In an exemplary embodiment, a screen 200 displays a search path based on a search keyword 210. The user may easily determine how the potential customer reaches the targeted target keyword through the screen 200, and may determine the competitor searched by the potential customer or the need desired by the potential customer.

In an exemplary embodiment, the terminal 120 may display an object for receiving a user input for at least one of a search keyword, a location of the search keyword within the search path (i.e., a base search path), or an alignment criterion of the search path (i.e., the base search path).

The object may include a search window 210 for receiving the search keyword, an object 220 for receiving the location of the search keyword within the search path, and/or an object 230 for receiving the alignment criterion of the search path.

The search keyword may be input by the user through the search window 210. The terminal 120 may display a plurality of other keywords (or recommendation keywords) associated with the search keyword.

The location of the search keyword may be an option of the user for selecting a method for displaying the search path. The location of the search keyword may indicate where a location of the search keyword is in the search path. For example, the location of the search keyword may include “entirety”, “start”, and/or “end”. In response to the location of the search keyword being “entirety”, the terminal 120 may display a first keyword 261 located in a previous path of the search keyword and a second keyword 262 located in a subsequent path of the search keyword. In response to the location of the search keyword being “start”, the terminal 120 may display the second keyword located on the subsequent path of the search keyword. In response to the location of the search keyword being “end”, the terminal 120 may display the first keyword located on the previous path of the search keyword.

For example, in response to that the location of the search keyword being “entirety”, the terminal 120 may display, on the screen 200, the first keyword 261 located before the search keyword 260 and the second keyword 262 located after the search keyword 260, based on the search keyword 260 in the search path input through the search window. Accordingly, the user may confirm a search path flowing into the search keyword, and further confirm the search path of what kind of search the potential customer has performed after the search keyword.

The alignment criterion of the search path may be for aligning keywords to be included in the search path. For example, the alignment criterion of the search path may include an order in which a search volume is high, an order in which a sum of distances between keywords is close, a high CPC, and/or a low CPC. The terminal 120 may determine the keyword included in the search path according to the alignment criterion of the search path determined based on the input of the user.

In an exemplary embodiment, the terminal 120 may display a second search path display object 240 on the screen 200. A second search path may be generated based on a keyword cluster generated according to a result of clustering a plurality of users and the first search path. The keyword cluster may be generated based on search data of the plurality of users. The keyword cluster may be generated based on search data of user having the same search intention. For example, the keyword cluster may include keywords searched by users having the same search intention and a relationship between the keywords. Through the keyword cluster, a user may determine a search intention of a potential customer through keywords included in one keyword cluster.

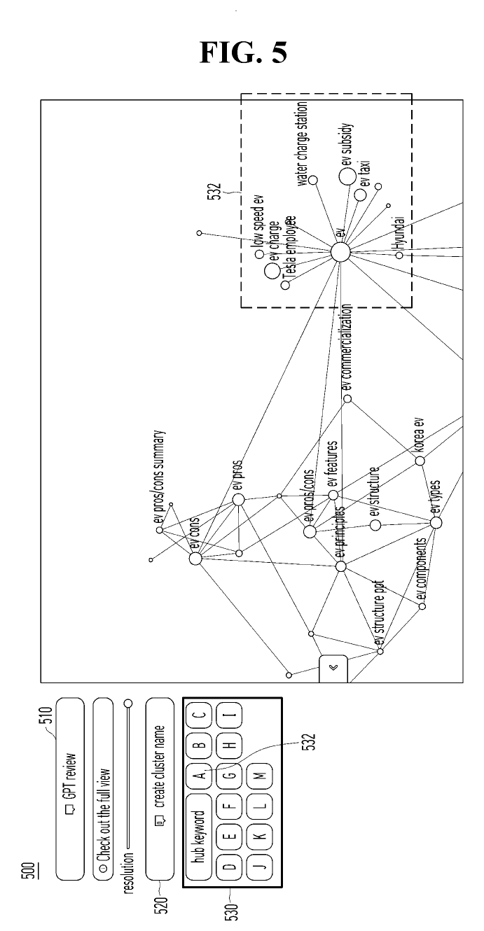

As the terminal 120 receives the user input for the second search path display object 240, the terminal 120 may display a screen 500 of FIG. 5. The screen 500 is specifically described below in FIG. 5.

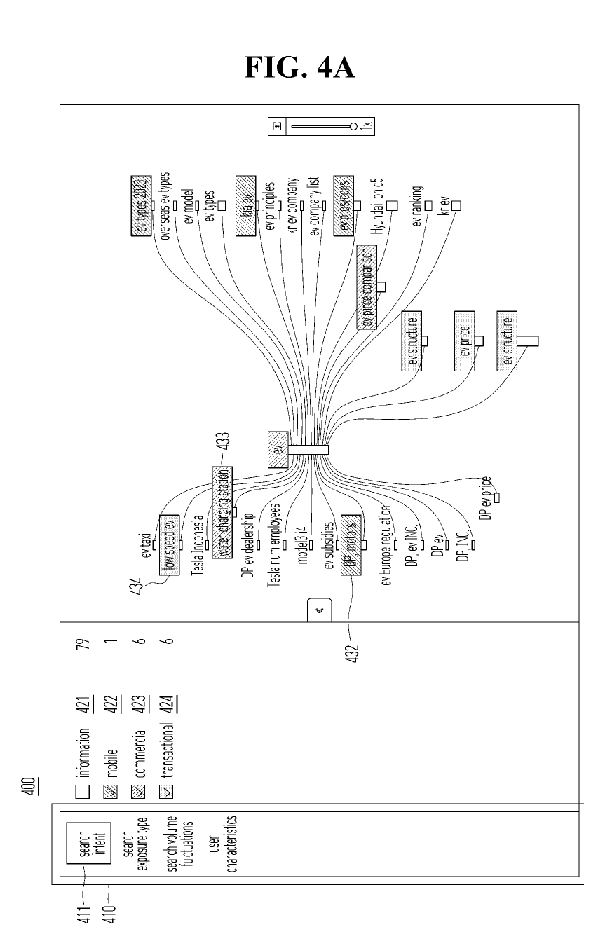

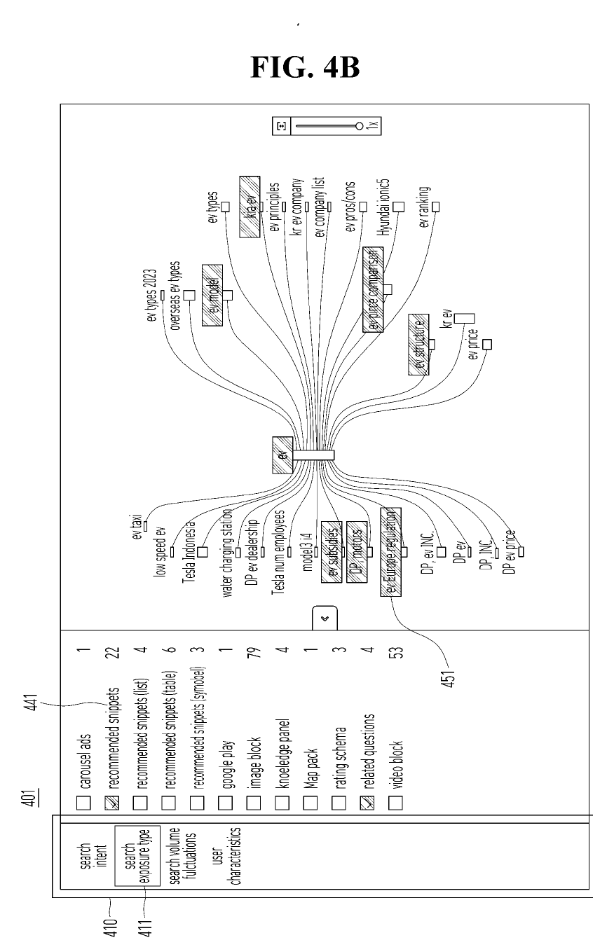

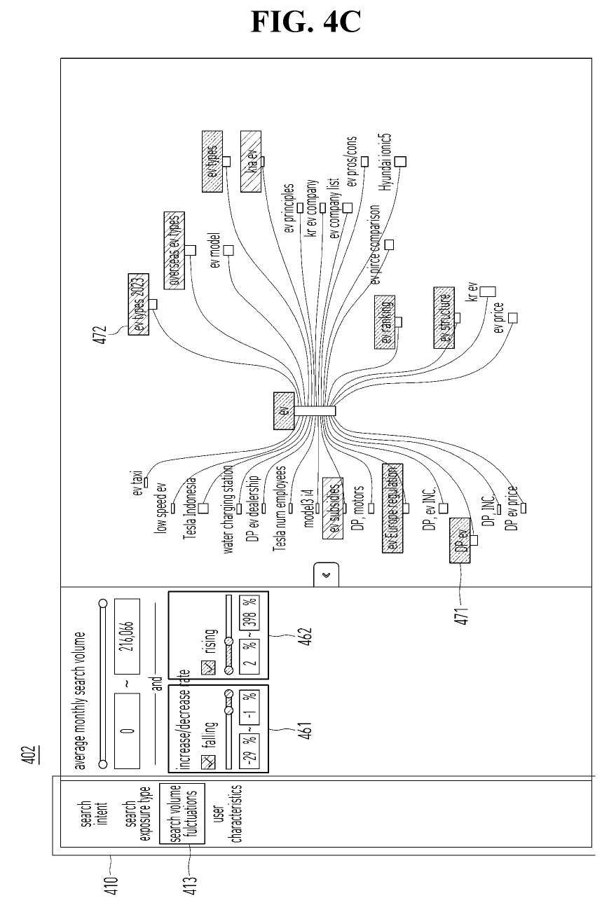

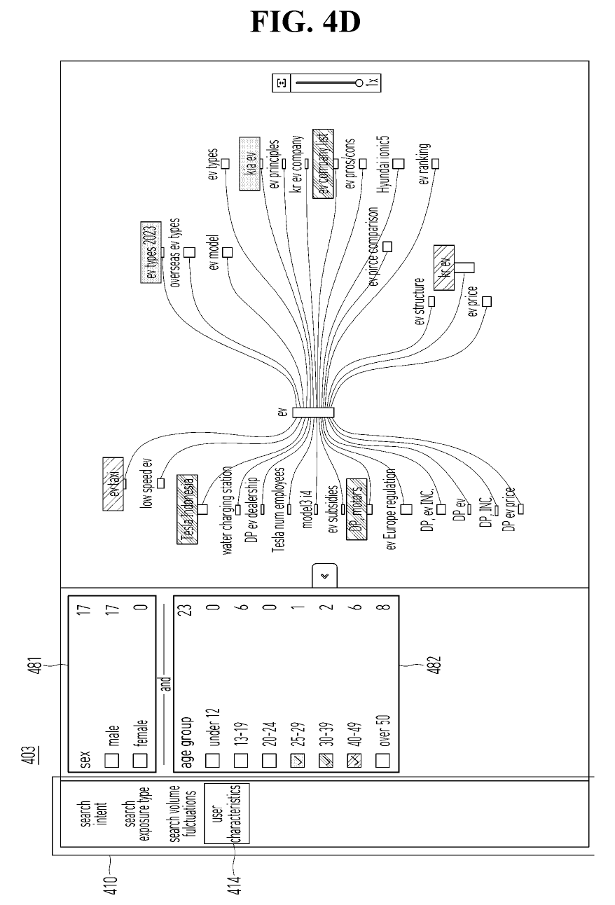

In an exemplary embodiment, the terminal 120 may display a keyword classification object 250 on the screen 220. The keyword classification object 250 may provide an identifier to a keyword so that the user may identify and view a desired keyword in the search path based on the search keyword. The keyword classification object 250 may be for displaying an identifier in a keyword corresponding to a filter according to a filter determined based on a user input. Accordingly, the user may selectively view only keywords to be analyzed from among numerous keywords displayed on the search path. Descriptions of the filter are specifically described below in FIGS. 4A to 4D.

In an exemplary embodiment, the terminal 120 may display the first search path including at least one of the first keyword 261 located before the search keyword or the second keyword 262 located after the search keyword based on the location of the search keyword, in response to receiving a user input for at least one of the search keyword, the location of the search keyword, or the alignment criterion.

In an exemplary embodiment, according to a determination that the location of the search keyword is a first location indicating the “entirety” of the search path (i.e., the base search path), the terminal 120 may display the first keyword 261 in a previous path of the search keyword on the first search path, and display the second keyword 262 in a subsequent path. Therefore, the first search path may include the first keyword 261, the search keyword 260, and the second keyword 262, and may further include a connection relationship between the first keyword 261 and the search keyword 260 and a connection relationship between the search keyword 260 and the second keywords 262. Accordingly, the user may view both the first keyword 261, which is introduced as the search keyword, and the second key word 262, which is searched after the search keyword, so that the user may know how a potential customer is introduced to the search keyword and which keyword is input after the search keyword to search, and thus may determine a search intention and a search path of an overall potential customer.

In an exemplary embodiment, according to a determination that the location of the search keyword is a second location indicating the “start” of the search path (i.e., the base search path), the terminal 120 may display the second keyword 262 in a subsequent path of the search keyword on the first search path. Accordingly, the user may analyze the keyword of the potential customer proceeding after the search keyword to determine the search intention of the potential customer after the search keyword.

In an exemplary embodiment, according to a determination that the location of the search keyword is a third location indicating the “end” of the search path (i.e., the base search path), the terminal 120 may display the first keyword 261 in a previous path of the search keyword on the first search path. Accordingly, the user may analyze the keyword of the potential customer proceeding before the search keyword to determine the search intention of the potential customer before the search keyword. That is, the user may analyze with which keyword the potential customer reaches the search keyword.

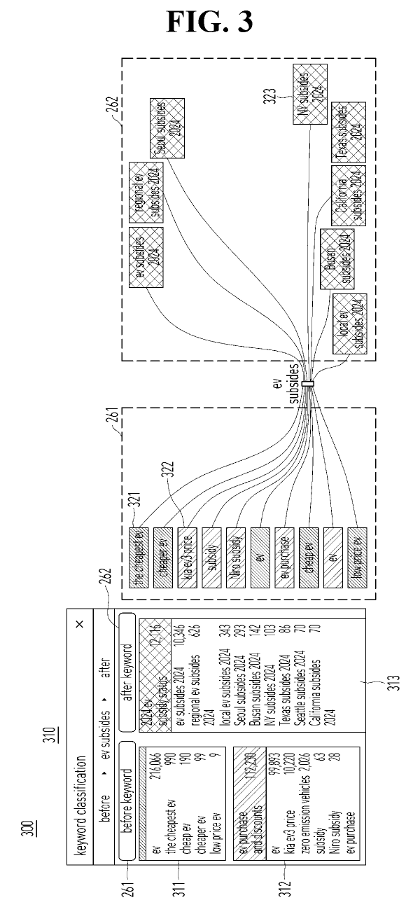

FIG. 3 is a diagram for describing a first keyword and a second keyword according to an exemplary embodiment of the present disclosure.

In an exemplary embodiment, based on a user input for keyword clustering, the terminal 120 may display at least one of a result of clustering the first keyword or a result of clustering the second keyword in the first search path. Based on the user input for the keyword classification object 250 of FIG. 2, the terminal 120 may display at least one of the result of clustering the first keyword or the result of clustering the second keyword on a screen 300.

The screen 300 displays the first keyword 261 and the second keyword 262. The screen 300 may include an area in which the first search path including the search keyword 260, the first keyword 261, and the second keyword 262 is displayed. The corresponding area may be displayed in a right area of the screen 300. The server 110 may generate a plurality of first keyword classification collections by clustering keywords included in the first keyword 261. For example, the server 110 may cluster a keyword based on a similarity between keywords. In addition, the server 110 may generate a plurality of second keyword classification collections by clustering keywords included in the second keyword 262. The terminal 120 may display the first keyword classification collection and the second keyword classification collection in a left area 310 of the screen 300 in the screen 300.

For example, the terminal 120 may display an identifier in a keyword A 321 included in a first keyword classification collection A 311 in the first search path. In the present disclosure, displaying the identifier may be imparting a visual effect to the keyword. For example, displaying the identifier may mean displaying a color of the keyword differently, displaying a highlight on the keyword, or imparting a sparkle effect to the keyword.

For example, the terminal 120 may display, in a keyword B 322 included in a first keyword classification collection B 312, an identifier corresponding to the first keyword classification collection B 312, in the first search path. The identifier corresponding to the first keyword classification collection B 312 may be different from the identifier corresponding to the first keyword classification collection A 311.

As another example, the terminal 120 may display, in a keyword C 323 included in a second keyword classification collection A 313, an identifier corresponding to the second keyword classification collection A 313, in the first search path. The identifier corresponding to the second keyword classification collection A 313 may be different from the identifiers corresponding to the first keyword classification collections A 311 and B 312.

Accordingly, the user may identify which keyword from among the plurality of keywords included in the first search path is included in a specific keyword classification collection, and thus may determine the search intention of the potential customer and a need of a customer based on the keyword classification collection.

FIGS. 4A to 4D are diagrams illustrating filters according to various exemplary embodiments of the present disclosure.

In an exemplary embodiment, the terminal 120 may display, on a left side of a screen, a filter object 410 for selecting and displaying a keyword determined based on a filter in the first search path. The filter may be for displaying an identifier with respect to a keyword included in the first search path based on a result classified based on a predetermined criterion according to a user input. Through the filter, the user may determine a search intention of a targeted potential customer and select a keyword that is efficient for marketing.

The screen 400 of FIG. 4A may be a result of responding to a user input for a first filter 411. The terminal 120 may display, according to a determination that the filter input through the filter object 410 is a first filter 411 that allows the search intention to be displayed in the keyword, an identifier corresponding to the search intention in the first search path, in the keyword. The search intention is an intention to find an answer to a specific question. The search intention may include at least one of a first intention 421 to find an answer to a query, a second intention 422 to find a specific website, a third intention 423 to find information about a specific product, or a fourth intention 424 to search for a purchase condition and a timing with purchase of a specific product in mind. For example, in accordance with the user selecting the second intention 422, the third intention 423, and the fourth intention 424, the terminal 120 may display identifiers for a keyword A 432 corresponding to the second intention 422, a keyword B 433 corresponding to the third intention 423, and a keyword C 434 corresponding to the fourth intention 424, respectively. The identifiers for the keyword A 432, the keyword B 433, and the keyword C 434, respectively, may be displayed with different visual effects.

A screen 401 of FIG. 4B may be a result of responding to a user input for a second filter 412. The terminal 120 may display, according to a determination that the filter input through the filter object 410 is the second filter 412 which allows a search exposure type, in which the keyword is exposed, to be displayed in a search result page, an identifier corresponding to the search exposure type in the keyword. The search exposure type may mean various forms in which a search result content is displayed in the search result page (e.g., search engine result page (SERP)). Examples of the search exposure type may include an organic search result, a paid search advertisement, and/or a snippet. For example, as a user input for a “recommended snippet 441” in the second filter 412 is received, the terminal 120 may display an identifier for a keyword “European electric vehicle purchase 451”. Accordingly, the user may identify, at a glance, a keyword that is frequently exposed for each search exposure type in the search result page in the search path. Accordingly, the user may easily select a keyword for search engine optimization.

A screen 402 of FIG. 4C may be a result of responding to a user input for a third filter 413. The terminal 120 may display, according to a determination that the filter input through the filter object 410 is the third filter 413 which allows search volume variation information to be displayed in the keyword, an identifier corresponding to the search volume variation information in the first search path, in the keyword. The search volume variation information may include how much a search volume of a specific keyword varies at a predetermined time point compared to a past time point. Through the search volume variation information, the user may confirm which keywords have seen a decrease or increase in search volume, thereby determining an interest of the potential customer. For example, the terminal 120 may receive a user input for a search volume decrease 461 and a decrease range in the third filter 413. For example, the terminal 120 may receive, from the user, an input that the decrease range is -29% to -1%. The terminal 120 may display an identifier for a keyword “principle of electric vehicle 471” corresponding to the search volume decrease 461. As another example, the terminal 120 may receive a user input for a search volume increase 462 and an increase range in the third filter 413. For example, the terminal 120 may receive, from the user, an input that the increase range is 2% to 398%. The terminal 120 may display an identifier for a keyword “low-speed electric vehicle 472” corresponding to the search volume increase 462. The terminal 120 may distinguish the identifier corresponding to the keyword of the search volume decrease 461 and the identifier corresponding to the keyword of the search volume increase 462 differently from each other. Accordingly, the user may determine which keyword tends to be less interested by the potential customer and which keyword tends not to be more interested by the potential consumer.

A screen 403 of FIG. 4D may be a result of responding to a user input for a fourth filter 414. The terminal 120 may display, according to a determination that the filter input through the filter object 410 is the fourth filter 414 which allows a demographic characteristic to be displayed in the keyword, an identifier corresponding to the demographic characteristic, in the keyword. The demographic characteristic means various variables that describe characteristics of a specific population group. For example, the demographic characteristic may include age 482, gender 481, income, education level, occupation, residence, and the like. For example, according to receiving a user input for “female” in the gender 481 and “25 to 29 years old”, “30 to 39 years old”, and “40 to 49 years old” in the age 482, the terminal 120 may display identifiers in keywords corresponding to “25 to 29 year old”, “ 30 to 39 year old”, and "40 to 49 year old”, respectively. The terminal 120 can display identifiers for keywords corresponding to each age group differently for each age group.

FIG. 5 is a diagram illustrating a keyword cluster according to an exemplary embodiment of the present disclosure.

In an exemplary embodiment, the terminal 120 may display the second search path generated based on a keyword cluster, which is generated according to a result of clustering a plurality of users, and the first search path. The keyword cluster may be generated based on search data of the plurality of users.

In an exemplary embodiment, the terminal 120 may display a name of a keyword cluster generated based on a keyword included in the keyword cluster. A language model review 510 may be for inputting the keyword, included in the keyword cluster, into a language model, and obtaining an analysis result thereof. The language model may be an artificial intelligence model specialized in natural language processing. The user may obtain an insight based on the keyword cluster based on the analysis result. A cluster name generation object 520 may be for generating a keyword cluster name based on a keyword included in a keyword cluster selected by the user. For example, a name of a keyword cluster A 532 may be “electric vehicle potential purchaser” based on keywords “low-speed electric vehicle”, “electric subsidy”, and “electric taxi” included in the keyword cluster A 532.

In an exemplary embodiment, the terminal 120 may display a plurality of keyword clusters 530. According to receiving a user input for the keyword cluster A 532 among the plurality of keyword clusters 530, the terminal 120 may display an identifier in the keyword included in the keyword cluster A 532. The terminal 120 may assign different identifiers to the plurality of keyword clusters 530. Therefore, the user may recognize a keyword for each keyword cluster 530 in the first search path at a glance.

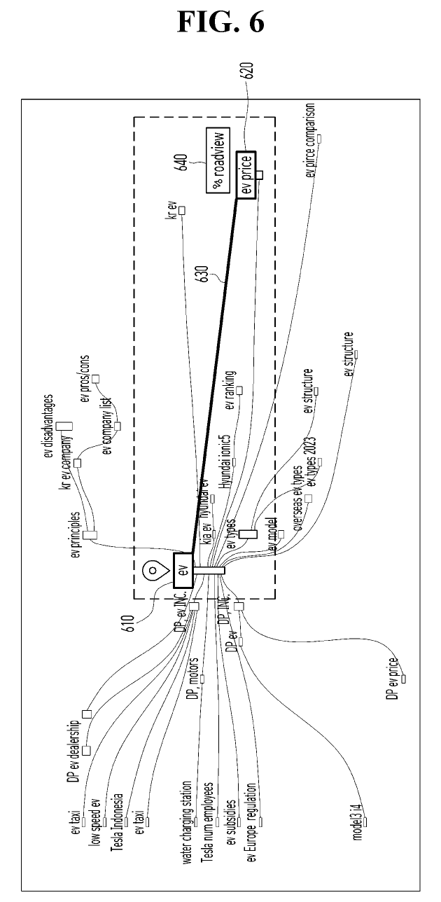

FIG. 6 is a diagram illustrating a third search path according to an exemplary embodiment of the present disclosure.

In an exemplary embodiment, the terminal 120 may receive, in the first search path, user inputs for a keyword 610 of a first point and a keyword 620 of a second point, the keywords 610 and 620 respectively indicating a start and an end of a third search path 630 for the user to desire to analyze, and display an identifier of the third search path 630 overlaid on the first search path. The third search path may be at least some of a plurality of search paths included in the first search path. The third search path is used to enable the user to selectively analyze only a selected search path among a plurality of search paths. Accordingly, the terminal 120 receives the user inputs for the keyword 610 of the first point and the keyword 620 of the second point in the first search path, and may determine the third search path 630. The terminal 120 may display an object 640 for confirming a detailed path for the third search path 630. The user may confirm a keyword included in the third search path 630 and the plurality of search paths through the object 640.

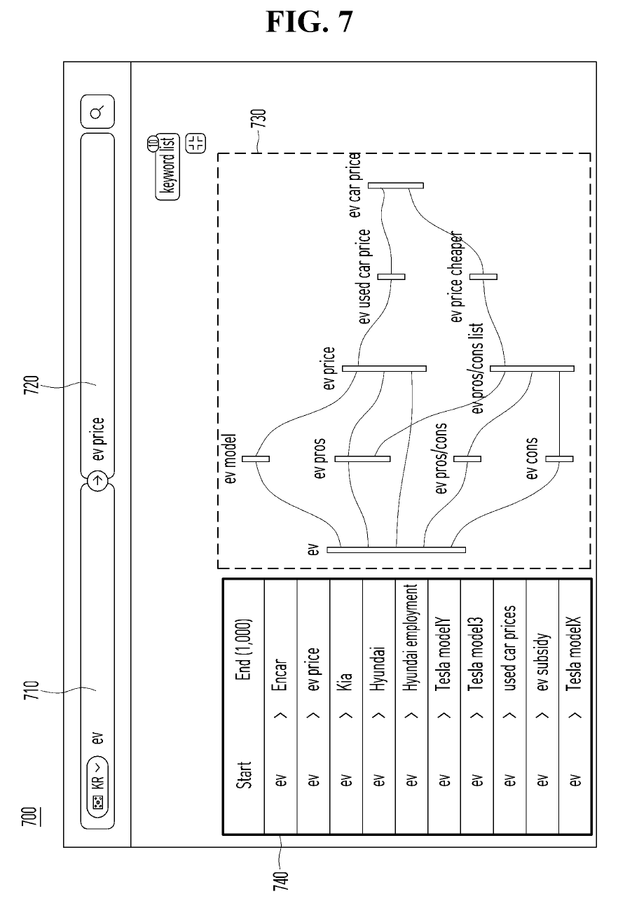

In an exemplary embodiment, the terminal 120 may switch the object 640 to and display a page displaying a fourth search path included in the third search path 630 according to a user input (e.g., the object 640) for the third search path 530. The page will be specifically described below in FIG. 7.

FIG. 7 is a diagram illustrating a fourth search path according to an exemplary embodiment of the present disclosure.

In an exemplary embodiment, the terminal 120 may display a list 740 of a fifth search path of keywords that are the same as the keyword 610 of the first point and are different from the keyword 620 of the second point in the corresponding page. An object A 710 may be to receive the keyword 610 of the first point, and an object B 720 may be to receive the keyword 620 of the second point. The list 740 of the fifth search path may be determined according to the keywords input through the object A 710 and the object B 720. The user may confirm, through the list 740 of the fifth search path, not only the fourth search path 730 but also another search path which is a keyword in which the keyword 610 of the first point is the same and an end point is different. Based on a user input for one of fifth search paths displayed in the list 740 of the fifth search path, the search path corresponding to the user input may be displayed in a left area of a screen 700.

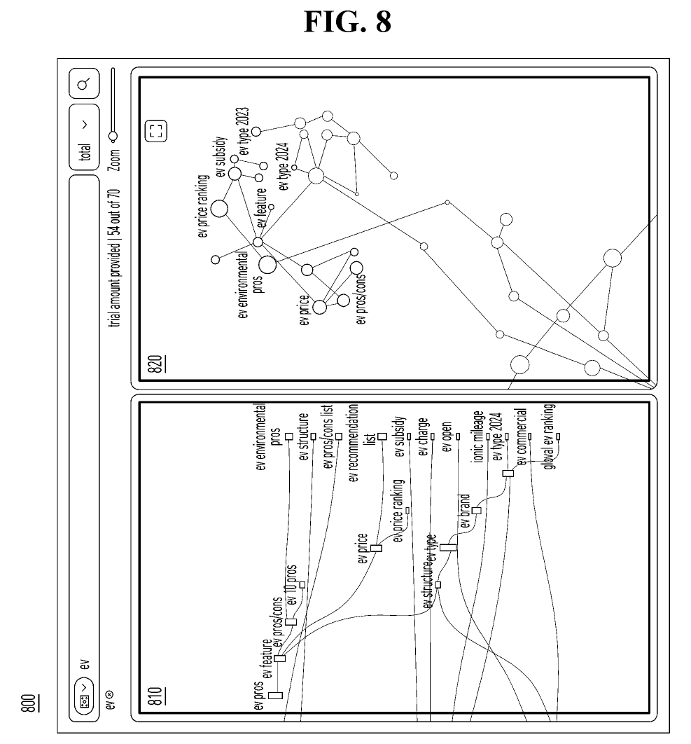

FIG. 8 is a diagram illustrating a screen for displaying a first search path and a second search path according to an exemplary embodiment of the present disclosure.

In an exemplary embodiment, the terminal 120 may display the first search path in a first area 810 of a screen 800, and display the second search path in a second area 820 of the screen. Accordingly, the user may determine the search intention of the potential customer through the first search path and the second search path. In addition, the user may determine a difference between search paths of the first area 820 and the second area 810 through the screen 800.

In an exemplary embodiment, the terminal 120 may display an identifier of a keyword included in a keyword cluster selected in the second search path, in the first search path of the first area 810. For example, in response to the user selecting a specific keyword cluster in the second area 820, the terminal 120 may display an identifier of a keyword, included in the keyword cluster, in the first area 810.

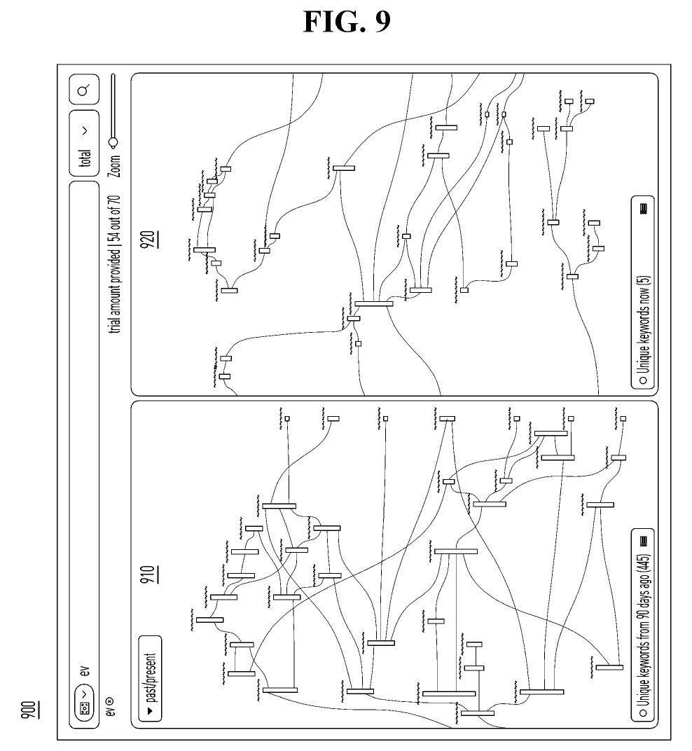

FIG. 9 is a diagram illustrating a screen for displaying a first search path at a first time point and a first search path at a second time point according to an exemplary embodiment of the present disclosure.

In an exemplary embodiment, the terminal 120 may display a first search path of a first time point in a first area 910 of a screen 900, and display a first search path of a second time point, which is a time point earlier than the first time point, in a second area 920 of the screen 900. For example, when the first time point is a current time point, and the second time point is 90 days before the current time point, the user may determine a difference between a first search path from 90 days ago and a first search path at the current time point. In this case, the first search path may be based on the same search keyword. Accordingly, the user may determine a change in the search path over time.

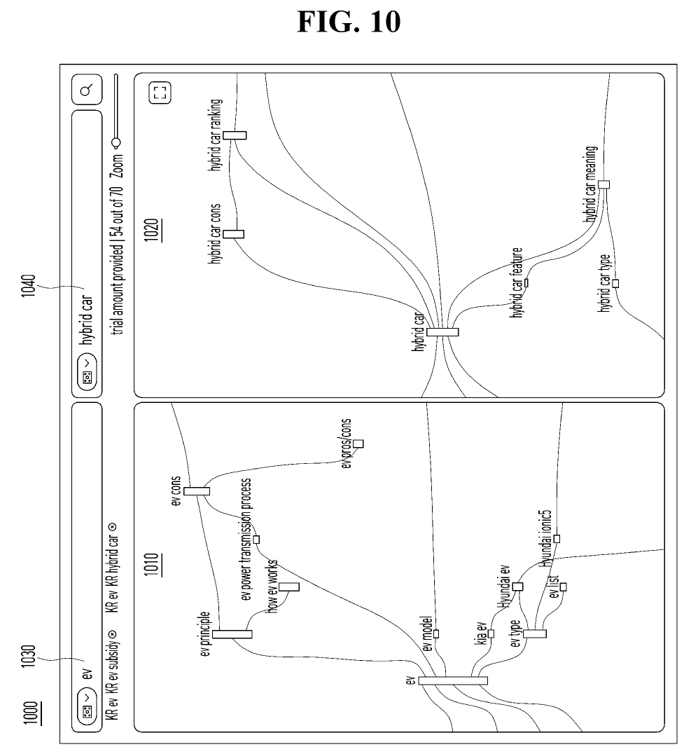

FIG. 10 is a diagram illustrating a screen for displaying a search path of a first search keyword and a search path of a second search keyword according to an exemplary embodiment of the present disclosure.

In an exemplary embodiment, the terminal 120 may display a first object 1030 for receiving a first search keyword displayed in a first area 1010 of a screen 1000 and a second object 1040 for receiving a second search keyword displayed in a second area 1020 of the screen 1000. Accordingly, the user may confirm a difference between respective first search paths based on different search keywords.

In an exemplary embodiment, the terminal 120 may display the search path of the first search keyword, input through the first object 1030, in the first area 1010. The terminal 120 may display the search path of the second search keyword, input through the second object 1040, in the second area 1020. For example, according to a user input in which the first search keyword is “electric vehicle” and the second search keyword is “hybrid vehicle”, a search path based on “electric vehicle” may be displayed in the first area 1010, and a search path based on “hybrid vehicle” may be displayed in the second area 1020.

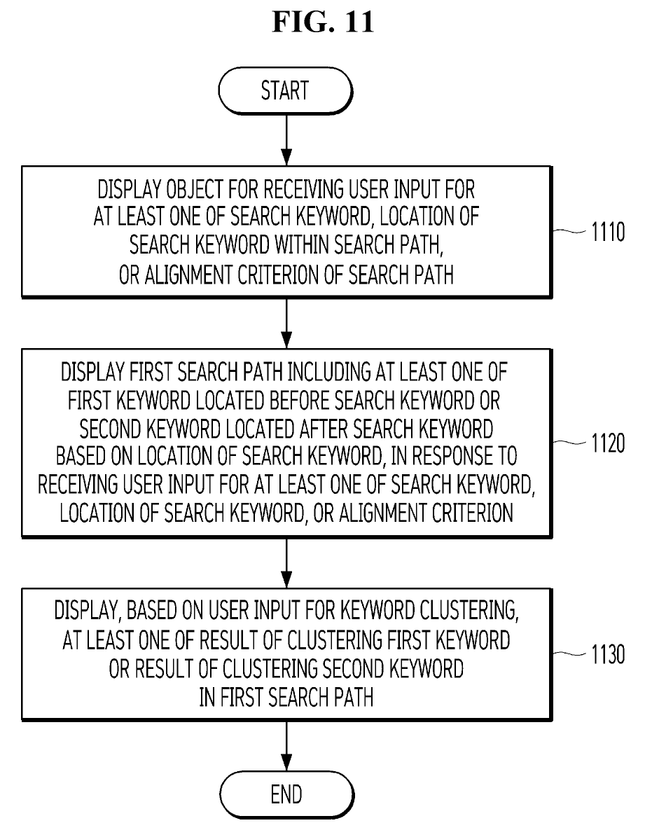

FIG. 11 is a flowchart illustrating a method for displaying a search path according to an exemplary embodiment of the present disclosure.

In an exemplary embodiment, an electronic apparatus may display an object for receiving a user input for at least one of a search keyword, a location of the search keyword within the search path, or an alignment criterion of the search path (1110).

In an exemplary embodiment, the electronic apparatus may display the first search path including at least one of the first keyword located before the search keyword or the second keyword located after the search keyword based on the location of the search keyword, in response to receiving a user input for at least one of the search keyword, the location of the search keyword, or the alignment criterion (1120).

In an exemplary embodiment, based on a user input for keyword clustering, the electronic apparatus may display at least one of a result of clustering the first keyword or a result of clustering the second keyword in the first search path (1130).

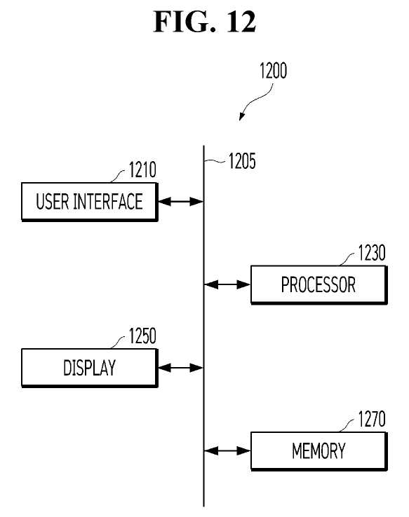

FIG. 12 is a diagram illustrating an electronic apparatus according to various exemplary embodiments of the present disclosure.

An electronic apparatus 1200 according to an exemplary embodiment may be a server or a user terminal (e.g., a mobile device, a desktop, a laptop, a personal computer, etc.). Referring to FIG. 12, the electronic apparatus 1200 may include a user interface 1210, a processor 1230, a display 1250, and a memory 1270. The user interface 1210, the processor 1230, the display 1250, and the memory 1270 may be connected to one another through a communication bus 1205.

The user interface 1210 includes anything that enables human-machine interaction. This may allow a user to manipulate and control systems, software, applications, websites, and the like. Examples of the user interface may include a graphical user interface, a text-based interface, a voice user interface, a natural user interface (e.g., gestures, touches, etc.), and the like.

The display 1250 may display information generated by the processor 1230.

The memory 1270 may store generated information. In addition, the memory 1270 may also store various information generated in a processing process of the processor 1230. In addition, the memory 1270 may store various data, programs, and the like. The memory 1270 may include a volatile memory or a non-volatile memory. The memory 1270 may include a mass storage medium such as a hard disk to store various data.

Further, the processor 1230 may perform at least one method or an algorithm corresponding to at least one method described above with reference to FIGS. 1 to 11. The processor 1230 may be a data processing device implemented as hardware having a circuit having a physical structure for executing desired operations. For example, the desired operations may include a code or instructions contained in the program. For example, the processor may be constituted by a central processing unit (CPU), a graphics processing unit (GPU), or a neural network processing unit (NPU). Examples of an electronic apparatus implemented in hardware may include a microprocessor, a central processing device, a processor core, a multi-core processor, a multiprocessor, an application-specific integrated circuit (ASIC), and a field programmable gate array (FPGA).

The processor 1230 may execute a program and control an electronic apparatus. A program code executed by the processor 1230 may be stored in a memory.

Meanwhile, the exemplary embodiments disclosed in this specification may be implemented in the form of a recording medium storing instructions executable by the computer. The instructions may be stored in the form of a program code and when the instructions are executed by a processor, the instructions generate a program module to perform operations of the disclosed embodiments. The recording medium may be implemented as a computer-readable recording medium. Examples of the computer-readable recording medium may include all kinds of recording media storing instructions which may be decoded by the computer. Examples of the computer-readable recording medium may be a ROM, a RAM, a magnetic tape, a magnetic disk, a flash memory, an optical data storage device, and the like.

The above-described contents are specific exemplary embodiments for carrying the present disclosure. The present disclosure will include not only the above -described embodiments, but also embodiments that may be simply changed in design or easily changed. In addition, the present disclosure will also include technologies that can be easily modified and carried out using the aforementioned embodiments. Therefore, the scope of the present disclosure should not be limited to the aforementioned exemplary embodiments and should be defined by the appended claims of the present disclosure and equivalents to the appended claims.

What is claimed is:

1. A method for displaying a search path, the method comprising:
displaying an object for receiving a user input for at least one of a search keyword, a location of the search keyword within a base search path, or an alignment criterion of the base search path;
displaying a first search path including at least one of a first keyword located before the search keyword or a second keyword located after the search keyword based on the location of the search keyword, in response to receiving a user input for at least one of the search keyword, the location of the search keyword, or the alignment criterion; and
displaying, based on a user input for keyword clustering, at least one of a result of clustering the first keyword or a result of clustering the second keyword in the first search path.

2. The method of claim 1, further comprising:
displaying, according to a determination that the location of the search keyword is a first location indicating an entirety of the base search path, the first keyword on a previous path of the search keyword on the first search path, and displaying the second keyword on a subsequent path thereof;
displaying, according to a determination that the location of the search keyword is a second location indicating a start of the base search path, the second keyword on the subsequent path of the search keyword on the first search path; and
displaying, according to a determination that the location of the search keyword is a third location indicating an end of the base search path, the first keyword on the previous path of the search keyword on the first search path.

3. The method of claim 1, further comprising:
displaying, on a left side of a screen, a filter object for selecting a keyword determined based on a filter in the first search path and displaying an identifier.

4. The method of claim 3, further comprising:
displaying, according to a determination that the filter input through the filter object is a first filter that allows the search intention to be displayed in the keyword, an identifier corresponding to the search intention in the first search path, in the keyword;
displaying, according to a determination that the filter input through the filter object is a second filter that allows a search exposure type, in which the keyword is exposed, to be displayed in a search result page, an identifier corresponding to the search exposure type, in the keyword;
displaying, according to a determination that the filter input through the filter object is a third filter that allows search volume variation information to be displayed in the keyword, an identifier corresponding to the search volume variation information in the first search path, in the keyword; and
displaying, according to a determination that the filter input through the filter object is a fourth filter that allows a demographic characteristic to be displayed in the keyword, an identifier corresponding to the demographic characteristic in the first search path, in the keyword.

5. The method of claim 1, further comprising:
displaying a second search path generated based on a keyword cluster, which is generated according to a result of clustering a plurality of users, and the first search path,
wherein the keyword cluster is generated based on search data of the plurality of users.

6. The method of claim 5, further comprising:
displaying a name of the keyword cluster generated based on a keyword included in the keyword cluster.

7. The method of claim 1, further comprising:
receiving, in the first search path, user inputs for a keyword of a first point and a keyword of a second point, the keywords respectively indicating a start and an end of a third search path for the user to desire to analyze, and displaying an identifier of the third search path overlaid on the first search path.

8. The method of claim 7, further comprising:
switching the object to and displaying a page displaying a fourth search path included in the third search path according to a user input for the third search path.

9. The method of claim 8, further comprising:
displaying a list of a fifth search path of keywords that are the same as the keyword of the first point and are different from the keyword of the second point in the corresponding page.

10. The method of claim 1, further comprising:
displaying the first search path in a first area of a screen, and displaying a second search path in a second area of the screen; and
displaying an identifier of a keyword, which is included in a keyword cluster selected in the second search path, in the first search path of the first area.

11. The method of claim 1, further comprising:
displaying the first search path of a first time point in a first area of a screen, and displaying the first search path of a second time point, which is a time point earlier than the first time point, in a second area of the screen.

12. The method of claim 1, further comprising:
displaying a first object for receiving a first search keyword in a first area of a screen and a second object for receiving a second search keyword in a second area of the screen;
displaying a search path of the first search keyword, input through the first object, in the first area; and
displaying a search path of the second search keyword, input through the second object, in the second area.

13. A non-transitory computer-readable recording medium storing a program for displaying a search path that, when executed by at least one processor, causes the at least one processor to perform operations, wherein the operations comprise:
displaying an object for receiving a user input for at least one of a search keyword, a location of the search keyword within a base search path, or an alignment criterion of the base search path;
displaying a first search path including at least one of a first keyword located before the search keyword or a second keyword located after the search keyword based on the location of the search keyword, in response to receiving a user input for at least one of the search keyword, the location of the search keyword, or the alignment criterion; and
displaying, based on a user input for keyword clustering, at least one of a result of clustering the first keyword or a result of clustering the second keyword in the first search path.

14. An electronic apparatus comprising:
a memory; and
one or more processors,
wherein the one or more processors are configured to:
display an object for receiving a user input for at least one of a search keyword, a location of the search keyword within a base search path, or an alignment criterion of the base search path;
display a first search path including at least one of a first keyword located before the search keyword or a second keyword located after the search keyword based on the location of the search keyword, in response to receiving a user input for at least one of the search keyword, the location of the search keyword, or the alignment criterion; and
display, based on a user input for keyword clustering, at least one of a result of clustering the first keyword or a result of clustering the second keyword in the first search path.
